(19) United States
(12) Patent Application Publication
(10) Pub. No.: US 2022/0386443 A1
(43) Pub. Date: Dec. 1, 2022

(54) PLASMA AIR STERILIZER

(71) Applicant: BEIJING BEIQING BOYU AIR STERILIZATION TECHNOLOGY CO., LTD, Beijing (CN)

(72) Inventor: Sun Sun CHAN, Beijing (CN)

(73) Assignee: BEIJING BEIQING BOYU AIR STERILIZATION TECHNOLOGY CO., LTD, Beijing (CN)

(21) Appl. No.: 17/790,719

(22) PCT Filed: Dec. 14, 2021
(86) PCT No.: PCT/CN2021/137829

§ 371 Date: Jul. 1, 2022

(30) Foreign Application Priority Data
Dec. 14, 2020 (CN) 202011462795.X

(51) Int. Cl. H05H 1/24; F24F 8/20

(52) U.S. Cl. CPC H05H 1/24; F24F 8/20; H05H 2245/36

(57) ABSTRACT

A plasma air sterilizer includes a fan assembly, a plasma generator, a plasma generator channel, and a grounded metal isolation mesh, where the fan assembly is a drum-type fan with side air intake which generates uniform air stream to a flat channel and outputs the uniform air stream to the plasma generator channel; the plasma generator channel has a flat structure and is connected to the plasma generator; the plasma generator generates plasma to sterilize air; and the grounded metal isolation mesh is arranged at an outlet of the plasma generator channel. The air sterilizer has a flat structure, so as to facilitate the arrangement of the sterilizer on wall panels, roofs, and the like without occupying extra space. Moreover, a circulating plasma sterilization mode enables the continuous sterilization of indoor air, is not limited to local sterilization, and shows a prominent sterilization effect.

### CROSS REFERENCE TO THE RELATED APPLICATIONS

This application is the national phase entry of International Application No. PCT/CN2021/137829, filed on Dec. 14, 2021, which is based upon and claims priority to Chinese Patent Application No. 202011462795.X, filed on Dec. 14, 2020, the entire contents of which are incorporated herein by reference.

### TECHNICAL FIELD

The present invention belongs to the technical field of sterilization devices and, in particular, relates to a device for indoor air sterilization.

### BACKGROUND

As severe acute respiratory syndrome (SARS) viruses and coronaviruses have caused huge harm to human beings, people have shown increasing awareness of virus prevention.

There has always been virus-killing devices designed for people's work and life needs, such as a vacuum sterilizer, a horizontal steam sterilizer, horizontal and vertical pressure sterilizers, and a portable steam sterilizer. However, most of the above-mentioned devices are used in special places such as hospitals and laboratories and there are few sterilization devices used at workplace or home.

The daily sterilization devices are generally bulky, such as ultraviolet (UV) disinfection cabinets and high-temperature disinfection cabinets. These devices generally occupy a large space which can only achieve the sterilization of an area therein and cannot achieve the sterilization of other places.

In people's daily work and life, the most important thing is to maintain clean and fresh air. Therefore, devices especially designed to sterilize air have become the focus of attention, among which air sterilizers are most widely used. A principle of the air sterilizer is to achieve the purpose of air sterilization in a specified space through continuous circulation of air in an air sterilizer. For example, patent application 201980013583.2 provides an air sterilizer unit with at least one inlet and at least one outlet and the air sterilizer unit includes: (a) a filter housing with an inner space and at least one filter, where at least one UVC light source suitable for irradiating microorganisms is arranged in the inner space, the at least one filter has the ability to reduce or remove microorganisms from ambient air, and the filter is UVC-resistant and is arranged between the UVC light source and the at least one outlet; and (b) an air delivery unit, where the air delivery unit is configured to deliver ambient air from the at least one inlet into the filter housing, such that the ambient air is exposed to UVC light, then moves through the at least one filter, and moves through the at least one outlet.

However, this traditional sterilization device adopts a round pipe structure, resulting in large air resistance and exposure of high-voltage electrodes; thus, the device may be dangerous when used in non-device scenarios and is not suitable for home and office.

### SUMMARY

In order to solve the above problems, a first objective of the present invention is to provide a plasma air sterilizer, which adopts a flat structure design to reduce the footprint and can effectively improve the sterilization effect through circulation, thereby facilitating home and office use.

A second objective of the present invention is to provide a plasma air sterilizer, which adopts a plane to form a long channel that enables small air resistance and easy sealing and is provided with a grounded metal isolation mesh to prevent destructive electric shock caused by the insertion of a metal bar, making the sterilizer safe and reliable.

A third objective of the present invention is to provide a plasma air sterilizer, which adopts a sealed structural mode to make the entire sterilizer water-proof, adopts a power supply mode of 24 V safe voltage to avoid hidden safety hazards of electric shock, and is provided with a metal mesh to further shield positive and negative ions generated by the plasma assembly.

In order to achieve the above objectives, the present invention adopts the following technical solutions:

A plasma air sterilizer is provided, including at least a fan assembly, a plasma generator, a plasma generator channel, and a grounded metal isolation mesh, where the fan assembly is a drum-type fan with side air intake, which generates uniform air stream to a flat channel and outputs the uniform air stream to the plasma generator channel; the plasma generator channel has a flat structure and is connected to the plasma generator; the plasma generator generates plasma to sterilize air; and the grounded metal isolation mesh is arranged at an outlet of the plasma generator channel.

The air sterilizer designed in the present invention has a flat structure, which is convenient for the arrangement of the sterilizer on wall panels, roofs, and the like, does not occupy extra space, and facilitates the use. Moreover, a circulating plasma sterilization mode enables the continuous sterilization of indoor air, is not limited to local sterilization, and shows a prominent sterilization effect.

The fan assembly, the plasma generator, and the plasma generator channel may be all flat; the plasma generator may be arranged horizontally, one end of the plasma generator may be connected to a power cord together with the fan assembly, and the other end of the plasma generator may be aligned with the plasma generator channel; moreover, the fan assembly, the plasma generator, and the plasma generator channel may jointly form a flat square structure, so as to facilitate assembly or arrangement. In this way, the overall sealing is allowed to facilitate a waterproof design.

Furthermore, a division board may be arranged inside the plasma generator channel to divide an air flow to produce a laminar flow effect, so as to facilitate plasma sterilization.

Furthermore, three division boards may be arranged, and a spacer may be arranged on an inner wall of the plasma generator channel to support the three division boards.

Furthermore, an air inlet of the plasma generator channel may be also provided with a grounded metal isolation mesh.

Furthermore, an edge of the grounded metal isolation mesh may be provided with a snap; correspondingly, a frame of the plasma generator channel may be provided with a snap hole; and the arrangement and fixation of the grounded metal isolation mesh may be realized by inserting the snap into the snap hole.

Furthermore, the air sterilizer may further include two brackets; one of the brackets may be fixed at a side of the plasma generator channel, and the other one of the brackets may be fixed at a side of the plasma generator; thus, the air sterilizer may be arranged and fixed from the two sides.

Furthermore, the two brackets may be each provided with a folded surface bent outward, and the folded surface may be provided to arrange and fix screws to fix the air sterilizer on a wall panel, under a dining table, or on a roof.

The present invention has the following beneficial effects:

The present invention has a flat structure, which is convenient for the arrangement of the sterilizer on wall panels, roofs, and the like or under a dining table without occupying too much space, and facilitates the arrangement and use in an indoor environment. Moreover, a circulating plasma sterilization mode enables the continuous sterilization of indoor air, is not limited to local sterilization, and shows a prominent sterilization effect.

Moreover, the present invention adopts a plane to form a long channel that enables small air resistance and easy sealing and also adopts a grounded metal isolation mesh to prevent destructive electric shock caused by the insertion of a metal bar, making the sterilizer safe and reliable.

The above-mentioned structural mode of the present invention can adopt an overall sealing and water-proof design to make the entire sterilizer water-proof, a power supply mode of 24 V safe voltage to avoid hidden safety hazards of electric shock, and a metal mesh to further shield positive and negative ions generated by the plasma assembly.

### BRIEF DESCRIPTION OF THE DRAWINGS

FIG. 1 is a schematic structural diagram of the air sterilizer implemented by the present invention.

FIG. 2 is an exploded view of the air sterilizer implemented by the present invention.

FIG. 3 is a schematic diagram of a first application of the air sterilizer implemented by the present invention.

FIG. 4 is a schematic diagram of a second application of the air sterilizer implemented by the present invention.

In the figures, 1 represents a grounded metal isolation mesh, 2 represents a fan assembly, 3 represents a plasma generator, 4 represents a plasma generator channel, 5 represents a power cord, and 6 represents a diversion port.

### DETAILED DESCRIPTION OF THE EMBODIMENTS

In order to make the object, technical solutions, and advantages of the present invention more clear, the present invention is further described in detail below with reference to the drawings and examples. It should be understood that the specific examples described herein are merely intended to explain the present invention, rather than to limit the present invention.

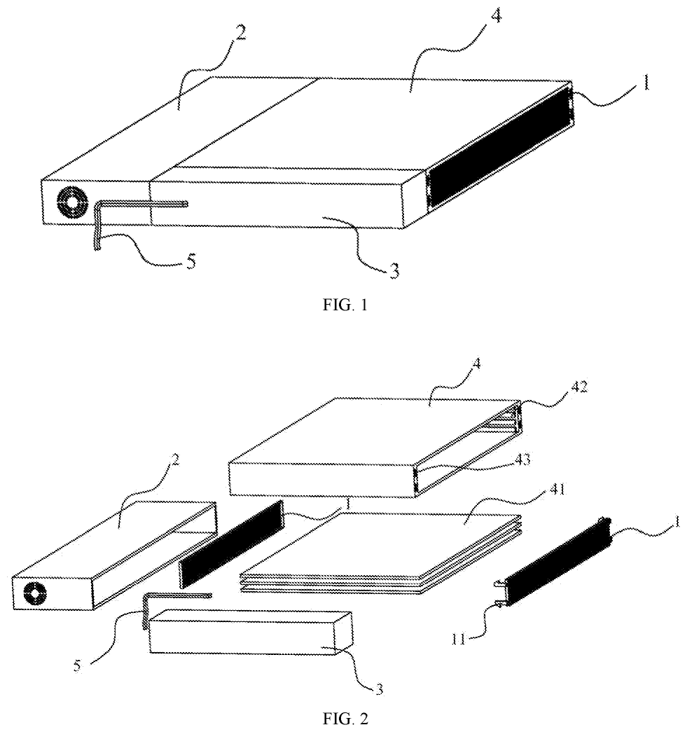

As shown in FIG. 1, the plasma air sterilizer implemented by the present invention at least includes a fan assembly 2, a plasma generator 3, a plasma generator channel 4, and a grounded metal isolation mesh 1.

The fan assembly 2 is a drum-type fan with side air intake, which generates uniform air stream to a flat channel and outputs the uniform air stream to the plasma generator channel 4; the plasma generator channel 4 has a flat structure and is connected to the plasma generator 3; and the plasma generator 3 generates plasma to sterilize air.

As shown in FIG. 2, three division boards 41 may be arranged inside the plasma generator channel 4, and a spacer 42 may be arranged on an inner wall of the plasma generator channel 4 to support the three division boards 41. The three division boards 41 may divide an air flow to produce a laminar flow effect, which is convenient for plasma sterilization.

A grounded metal isolation mesh 1 may be arranged at an outlet of the plasma generator channel 4, which plays an isolation role for safety protection and prevents a destroyer from being inserted into a high-voltage area; and the grounded metal isolation mesh 1 also can shield and filter possible positive and negative ions generated by the plasma generator channel 4. Thus, an air inlet of the plasma generator channel 4 may be also provided with a grounded metal isolation mesh 1.

An edge of the grounded metal isolation mesh 1 may be provided with a snap 11; correspondingly, a frame of the plasma generator channel 4 may be provided with a snap hole 43; and the arrangement and fixation of the grounded metal isolation mesh 1 may be realized by inserting the snap 11 into the snap hole 43.

The plasma generator 3 and the fan assembly 2 may be connected to a 24 V power supply through a power cord 5, and the 24 V power supply may provide power for the plasma generator 3 and the fan assembly 2 to avoid hazards caused by high voltage. The plasma generator 3 is an existing device capable of generating plasma and the fan assembly 2 is an existing drum-type fan, which can be realized by the existing technologies and thus will not be repeated here.

In order to match the flat structure of the plasma generator channel 4, the plasma generator 3 can also be designed into a flat shape.

In the sealed whole formed by a plasma high-voltage generation circuit 3 operating under a 24 V power supply and the plasma generator channel 4, a drum-type fan composed of a motor operating under a 24 V power supply generates an air flow, and the fan assembly 2 generates a strip-like air source; the air passes through the plasma generator channel 4 to play the role of air circulation sterilization; and the grounded metal isolation mesh 1 can not only prevent a destroyer from being inserted into a high-voltage area, but also shield and filter positive and negative ions generated by the plasma generator channel 4.

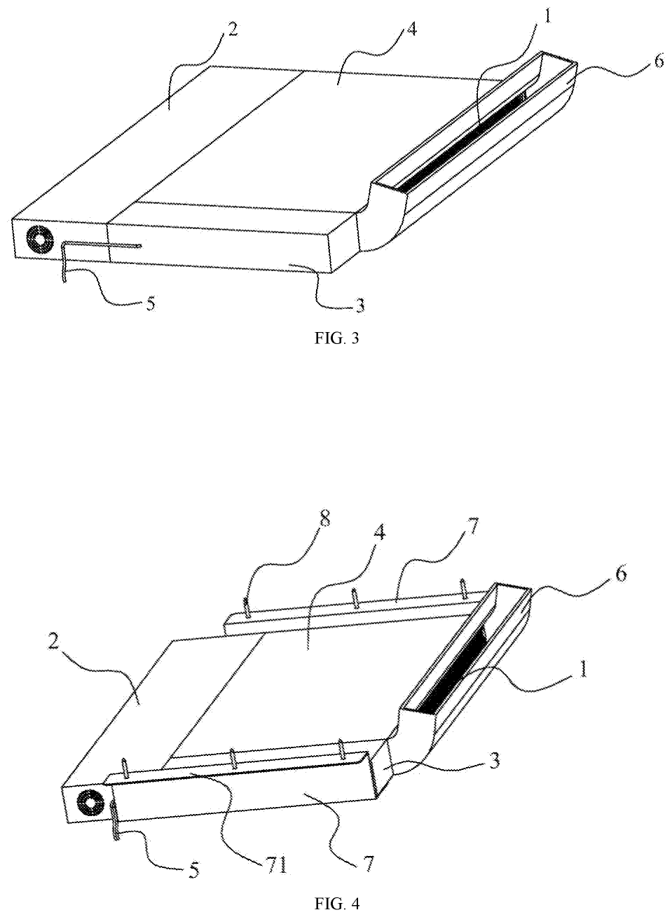

FIG. 3 shows a specific application form of the present invention. In this application of the present invention, in addition to the grounded metal isolation mesh 1, the fan assembly 2, the plasma generator 3, the plasma generator channel 4, and the power cord 5, a diversion port 6 is formed to make sterilized air flow in a specific direction, such that an output direction of the sterilized air can be controlled as required.

FIG. 4 shows another specific application form of the present invention. In this application of the present invention, brackets 7 are added on the basis of FIG. 3 for the convenience of arrangement. Specifically, in addition to the existing structures of grounded metal isolation mesh 1, fan assembly 2, plasma generator 3, plasma generator channel 4, power cord 5, and diversion port 6, two brackets 7 may be added, where one of the brackets may be fixed at a side of the plasma generator channel 4, and the other one of the brackets may be fixed at a side of the plasma generator 3; and the present invention may be arranged and fixed from the two sides.

The two brackets 7 may be each provided with a folded surface 71 bent outward, and the folded surface 71 may be provided to arrange and fix screws 8 to fix the present invention on a wall panel or a roof.

The present invention has a flat structure, which is convenient for the arrangement of the sterilizer on wall panels, roofs, and the like without occupying too much space, and facilitates the arrangement and use in an indoor environment. Moreover, a circulating plasma sterilization mode enables the continuous sterilization of indoor air, is not limited to local sterilization, and shows a prominent sterilization effect.

Moreover, the present invention adopts a plane to form a long channel that enables small air resistance and easy sealing and also adopts a grounded metal isolation mesh to prevent destructive electric shock caused by the insertion of a metal bar, making the sterilizer safe and reliable.

The above-mentioned structural mode of the present invention can adopt an overall sealing and water-proof design to make the entire sterilizer water-proof, a power supply mode of 24 V safe voltage to avoid hidden safety hazards of electric shock, and a metal mesh to further shield positive and negative ions generated by the plasma assembly.

The basic structure of the present invention is described above. In practical applications, the components of the present invention can be assembled into various products with different air flow rates according to actual needs and can also be assembled into a ceiling air duct-type sterilizer, where one component is adopted as a unit, and 1 to N units form a product series with different air volumes.

In summary, the present invention has a flat structure, which is convenient for the arrangement of the sterilizer on wall panels, roofs, and the like or under a dining table without occupying too much space, and facilitates the arrangement and use in an indoor environment. Moreover, a circulating plasma sterilization mode enables the continuous sterilization of indoor air, is not limited to local sterilization, and shows a prominent sterilization effect.

Moreover, the present invention adopts a plane to form a long channel that enables small air resistance and easy sealing and also adopts a grounded metal isolation mesh to prevent destructive electric shock caused by the insertion of a metal bar, making the sterilizer safe and reliable.

The above-mentioned structural mode can adopt an overall sealing and water-proof design to make the entire sterilizer water-proof, a power supply mode of 24 V safe voltage to avoid hidden safety hazards of electric shock, and a metal mesh to further shield positive and negative ions generated by the plasma assembly.

The above are merely preferred examples of the present invention, and are not intended to limit the present invention. Any modification, equivalent substitution, and improvement made without departing from the spirit and principle of the present invention shall be included within the protection scope of the present invention.

What is claimed is:

1. A plasma air sterilizer, comprising a fan assembly, a plasma generator, a plasma generator channel, and a first grounded metal isolation mesh, wherein the fan assembly is a drum-type fan with side air intake, the fan assembly generates a uniform air stream to a flat channel and the fan assembly outputs the uniform air stream to the plasma generator channel; the plasma generator channel has a flat structure and the plasma generator channel is connected to the plasma generator; the plasma generator generates a plasma to sterilize an air; and
the first grounded metal isolation mesh is arranged at an outlet of the plasma generator channel.

2. The plasma air sterilizer according to claim 1, wherein the fan assembly, the plasma generator, and the plasma generator channel are all flat; the plasma generator is arranged horizontally, a first end of the plasma generator is connected to a power cord together with the fan assembly, and a second end of the plasma generator is aligned with the plasma generator channel; and the fan assembly, the plasma generator, and the plasma generator channel jointly form a flat square structure, so as to facilitate an assembly or an arrangement.

3. The plasma air sterilizer according to claim 1, wherein a division board is arranged inside the plasma generator channel to divide the uniform air stream to produce a laminar flow effect, so as to facilitate a plasma sterilization.

4. The plasma air sterilizer according to claim 3, wherein three division boards are arranged, and a spacer is arranged on an inner wall of the plasma generator channel to support the three division boards.

5. The plasma air sterilizer according to claim 1, wherein an air inlet of the plasma generator channel is provided with a second grounded metal isolation mesh.

6. The plasma air sterilizer according to claim 5, wherein an edge of the first grounded metal isolation mesh is provided with a snap; correspondingly, a frame of the plasma generator channel is provided with a snap hole; and an arrangement and fixation of the first grounded metal isolation mesh is realized by inserting the snap into the snap hole.

7. The plasma air sterilizer according to claim 1, further comprising two brackets, wherein a first bracket of the two brackets is fixed at a side of the plasma generator channel, and a second bracket of the two brackets is fixed at a side of the plasma generator; and the plasma air sterilizer is arranged and fixed from the side of the plasma generator channel and the side of the plasma generator.

8. The plasma air sterilizer according to claim 7, wherein the two brackets are each provided with a folded surface bent outward, and the folded surface is provided to arrange and fix screws.
